(19) United States
(12) Patent Application Publication
(10) Pub. No.: US 2024/0343613 A1
(43) Pub. Date: Oct. 17, 2024

(54) POINT-OF-USE LIQUID TREATMENT

(71) Applicant: Crystal IS, Inc., Green Island, NY (US)

(72) Inventors: Rajul V. Randive, Niskayuna, NY (US); Richard M. Mariita, Green Island, NY (US); James Davis, Green Island, NY (US)

(21) Appl. No.: 18/133,094

(22) Filed: Apr. 11, 2023

(51) Int. Cl. C02F 1/32; C02F 1/00; C02F 9/00

(52) U.S. Cl. CPC C02F 1/32; C02F 1/001; C02F 9/00; C02F 2201/326; C02F 2303/04

(57) ABSTRACT

A liquid treatment system has a liquid inlet, a liquid storage system, a filter, an inline ultraviolet (UV) reactor, and a liquid outlet. The liquid inlet receives a liquid. The filter removes a contaminant from the liquid. The inline UV reactor mitigates impurities in the liquid. The liquid storage system, the filter, and the inline UV reactor form a liquid channel between the liquid inlet and the liquid outlet. The liquid outlet is downstream from the liquid inlet. The inline UV reactor and the filter are downstream of the liquid storage system.

### FIELD

Illustrative embodiments of the invention generally relate to liquid treatment and, more particularly, various embodiments of the invention relate to treatment at a point-of-use.

### BACKGROUND

Existing point-of-use water treatment suffers from a number of shortcomings and disadvantages. A point-of-use liquid treatment system may include filters and other elements to remove contaminants. Some of these removed contaminants deter other contaminants from thriving in the liquid treatment system. For example, contaminants like chlorine prevent microbial growth. Treated, stagnant water in a point-of-use system may foster bacterial growth between uses.

### SUMMARY OF VARIOUS EMBODIMENTS

In accordance with one embodiment of the invention, a liquid treatment system includes a liquid inlet, a liquid storage system, a filter, an inline ultraviolet (UV) reactor, and a liquid outlet. The liquid inlet receives a liquid. The filter removes a first contaminant from the liquid. The inline UV reactor mitigates a second contaminant in the liquid. The liquid storage system, the filter, and the inline UV reactor form a liquid channel between the liquid inlet and the liquid outlet. The liquid outlet is downstream from the liquid inlet. The inline UV reactor and the filter are downstream from the liquid storage system.

The liquid treatment system has a liquid storage system. In some embodiments, the liquid storage system includes a heat exchanger or a storage tank. In some embodiments, the liquid storage system includes a storage tank and a heating stage including a heat exchanger, wherein the storage tank and the heating stage form parallel liquid subchannels in the liquid channel. The liquid treatment system may not include a second downstream storage system from the inline UV reactor or the filter.

The liquid treatment system includes the filter structured to remove a first contaminant. In some embodiments, the first contaminant includes chlorine. The filter may include a carbon filter.

The inline UV reactor of the liquid treatment system may operate in a standby mode while the liquid treatment system is not dispensing the liquid. Operating in the standby mode may include periodically activating a UV-C light of the inline UV reactor.

In some embodiments, a maximum cross-sectional area of the liquid channel between the filter and the liquid outlet is less than 15 cm².

The liquid treatment system may have a pre-filter to remove a third contaminant from the liquid but not the contaminant removed by the filter.

In accordance with another embodiment, a method treats a liquid by operating a liquid treatment system. The liquid treatment system includes a liquid inlet, a liquid storage system, a filter, an inline ultraviolet (UV) reactor, and a liquid outlet. The method stores a liquid with the liquid storage system. Storing the liquid may include heating or cooling the liquid. The method filters a first contaminant from the stored liquid with the filter. The method also mitigates a second contaminant in the filtered liquid with the inline UV reactor.

Storing the liquid may include heating the liquid or cooling the liquid. The liquid may be stored with a liquid storage system such as a heat exchanger or a storage tank. The liquid storage system may have a storage tank and a heating stage including a heat exchanger, such that liquid storage system and the heating stage form parallel liquid subchannels.

The liquid treatment system does not include a second liquid storage system such that the second liquid storage system is downstream from the inline UV reactor or the filter.

The first contaminant may be chlorine and the filter may have a carbon filter. The method may include prefiltering the liquid before storing the liquid to remove a third contaminant, but not the contaminant removed by the filter.

In some embodiments, the method may operate the inline UV reactor in a standby mode while the liquid treatment system is not dispensing the liquid. Operating in standby mode may include periodically activating a UV-C light of the inline UV reactor.

In some embodiments, any cross section of the liquid channel between the filter and the liquid outlet has an area of less than 30 cm².

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 shows a liquid treatment system in accordance with various embodiments.

FIG. 2 is a flowchart showing a process for treating a liquid in accordance with various embodiments.

### DESCRIPTION OF ILLUSTRATIVE EMBODIMENTS

In illustrative embodiments, a point of use liquid treatment system has a liquid storage system which stores chlorinated liquid. Before the liquid is dispensed from the liquid treatment system, the liquid is filtered by a filter to remove the chlorine and doused by an ultraviolet light (UV) reactor. To prevent microbial growth in the system after the chlorine is removed, the UV reactor may periodically douse the stagnant water between uses. No liquid storage systems are placed after the filter. In this way, no liquid storage system of the system experiences microbial growth, since the liquid stored in the liquid storage system remains chlorinated. Details of illustrative embodiments are discussed below.

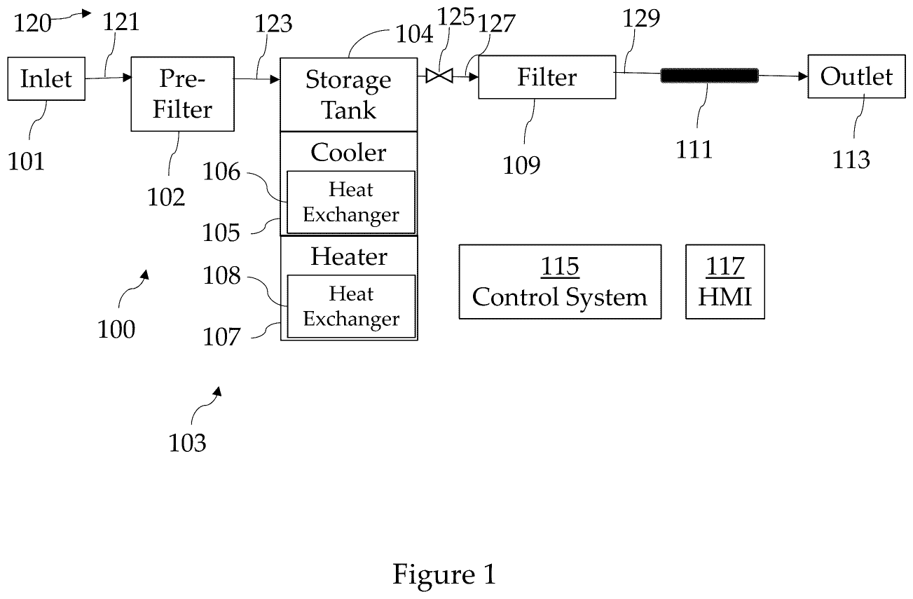

FIG. 1 schematically shows a liquid treatment system 100 configured to receive unfiltered liquid and dispense treated liquid. It should be appreciated that the liquid treatment system 100 may be implemented in a variety of applications, including point-of-use water treatment, among other things.

The liquid may be water, among other things. The unfiltered liquid received by the liquid treatment system 100 may include one or more contaminants. For example, the unfiltered liquid may have microbes (e.g., bio-film or mold), inorganic chemicals, organic chemicals, disinfection byproducts, or sediment, among other things. In some embodiments, the liquid has the contaminants to prevent or eliminate microbial growth (anti-microbial contaminants), such as chlorine, among other things.

The liquid treatment system 100 has a liquid inlet 101 to receive the liquid from a liquid source. The liquid inlet 101 may be a port configured to connect to a water line or another port, among other things.

The liquid flows through the liquid treatment system 100 in a liquid channel formed by components of the liquid treatment system 100 interconnected by connectors 120 configured to guide liquid along the liquid channel. Among other things, the connectors 120 may include tubing or ports, among other things.

The liquid treatment system 100 has a pre-filter 102 to receive liquid from the liquid inlet 101 by way of connector 121. The pre-filter 102 removes some of the contaminants from the liquid. For example, the pre-filter 102 may remove sediment from the liquid, but allow an anti-microbial contaminant to pass through the pre-filter 102. In other embodiments, the liquid treatment system 100 does not have the pre-filter 102.

The liquid treatment system 100 has a liquid storage system 103 to receive the pre-filtered liquid from the pre-filter 102 by way of the connector 123 and store the liquid. In the illustrated embodiment, the liquid storage system 103 has a storage tank. In some embodiments, the liquid storage system 103, such as the storage tank, is configured to hold at least twice the amount of liquid as the liquid channel between the liquid storage system 103 and the liquid outlet 113. In some embodiments, the liquid storage system 103 is configured to hold between two and ten times the amount of liquid, or more, as the liquid channel between the liquid storage system 103 and the liquid outlet 113. In some embodiments, the liquid storage tank holds 2 liters of liquid and has dimensions of approximately 12 cm×12 cm×20 cm.

In the illustrated embodiment, the liquid storage system 103 has a cooler 105 configured to cool liquid in the liquid storage system 103. In the illustrated embodiment, the cooler 105 has a heat exchanger 106 configured to thermally couple the liquid to a cooling medium. The heat exchanger 106 may be configured to cool the liquid within the storage tank 104. Alternatively, or in addition to cooling the liquid in the storage tank 104, the heat exchanger 106 may cool liquid as the liquid flows through a channel formed by the heat exchanger 106. In other embodiments, the liquid storage system 103 has a storage tank 104, but does not include a cooler 105.

In the illustrated embodiment, the liquid storage system 103 has a heater 107 configured to heat liquid in the liquid storage system 103. In the illustrated embodiment, the heater 107 has a heat exchanger 108 configured to thermally couple the liquid to a heating medium. The heat exchanger 108 may be configured to heat the liquid within the storage tank 104. Alternatively or in addition to heating the liquid in the storage tank 104, the heat exchanger 108 may heat liquid as the liquid flows through a channel formed by the heat exchanger 108. In other embodiments, the liquid storage system 103 has a storage tank 104, but does not include a heater 107.

The liquid treatment system 100 has a valve 125 to selectively allow the flow of liquid from the liquid storage system 103 towards the liquid outlet 113 configured to dispense the liquid. In the illustrated embodiment, the liquid treatment system 100 includes a single valve 125. It should be appreciated that the liquid treatment system 100 may have more than one controllable element to selectively allow the flow of liquid between components of the liquid treatment system 100. The liquid treatment system 100 may also have a different type of controllable element, such as a pump, among other things. Furthermore, the valve 125 may be located at another location in the liquid channel of the liquid treatment system 100.

The liquid treatment system 100 has a filter 109 for removing anti-microbial contaminants from the liquid. Among other things, the filter 109 may include a carbon filter or a reverse osmosis system. By not removing the anti-microbial contaminant from the liquid with the pre-filter 102, the liquid treatment system 100 protects the liquid in the liquid storage system 103 from microbial growth.

The liquid treatment system 100 has an inline UV reactor 111 configured to treat the liquid in the final connector 129 with ultraviolet light. The UV reactor 111 has a light, such as a light emitting diode, to douse the liquid in order to neutralize microbial growth in the portion of the liquid channel between the filter 109 and the liquid outlet 113. In some embodiments, the ultraviolet light is UV-C.

The UV reactor 111 may treat liquid as it is flowing through connector 129 to be dispersed from the liquid outlet 113. The UV reactor 111 may also treat liquid within the connector 129 while the liquid is stagnant. When liquid remains stagnant in connector 129, microbial growth introduced to the connector 129 from the liquid outlet 113 may increase. By periodically dousing stagnant liquid, the UV reactor 111 may reduce or eliminate microbial growth in the connector 129, and may prevent the microbial growth from spreading to other portions of the liquid treatment system 100.

The liquid outlet 113 receives the treated liquid from the UV reactor 111 and dispenses the treated liquid from the liquid treatment system 100. The liquid outlet 113 may have a nozzle or a port for connecting to a water line, among other things.

Components of the liquid treatment system 100 form a liquid channel between the liquid inlet 101 and the liquid outlet 113. In the illustrated embodiment, as the liquid flows through the liquid treatments system 100, the liquid first flows through the liquid inlet 101, then through the pre-filter 102, then through the liquid storage system 103, then through the valve 125, then through the filter 109, then through the UV reactor 111, and finally through the liquid outlet 113.

Between the filter 109 and the liquid outlet 113, the amount of liquid in the liquid channel may be less than the amount of liquid storable by the liquid storage system 103. For example, the liquid storage system 103 may be able to hold 3000 cm³ of liquid, while the liquid channel between the filter 109 and the liquid outlet 113, including the UV reactor 111, may hold 400 cm³ or less, such as a range between 125 cm³ and 400 cm³, among other things. In some embodiments, the maximum cross section of the liquid channel perpendicular to the flow of liquid along the liquid channel between the filter 109 and the liquid outlet 113 has an area of less than 60 cm² or 30 cm², including the cross sections of the components incorporated into the liquid channel, such as the UV reactor 111. In some embodiments, the maximum cross-sectional area of the liquid channel between the filter 109 and the liquid outlet 113 is less than 15 cm².

In preferred embodiments, the liquid storage system 103 is not located downstream of the filter 109 or the UV reactor 111, and the liquid treatment system does not have additional liquid storage systems between the filter 109 and the liquid outlet 113.

In some embodiments, the liquid storage system 103 forms parallel liquid subchannels allowing the liquid to flow through a selected one of the storage tank 104, the cooler 105, and the heater 107.

The liquid treatment system 100 includes a control system 115 to operate components of the liquid treatment system 100, such as the cooler 105, the heater 107, the valve 125, and the UV reactor 111, among other things.

The control system 115 operates the liquid treatment system 100 in at least two modes: a dispensing mode and a standby mode. During the dispensing mode, the liquid treatment system 100 dispenses liquid from the liquid outlet 113. The control system 115 begins to operate the liquid treatment system 100 in dispensing mode after receiving a request to dispense liquid from a human machine interface (HMI) 117. The HMI is configured to receive an input from a user indicating the request to dispense liquid. In some embodiments, the request to dispense liquid includes a request to adjust the temperature of the liquid. The HMI may include, among other things, a button, a switch, and keyboard, or a touch screen. The liquid may begin to flow through the filter 109 after the control system 115 opens the valve 125. As the liquid flows through the filter 109 to the liquid outlet 113, the liquid is doused with ultraviolet light by the UV reactor 111. In some embodiments, the UV reactor 111 continuously douses the liquid while operating in dispensing mode.

In the standby mode, liquid is not dispensed from the liquid outlet 113. Instead, the liquid may be stagnant within at least the portion of the liquid channel from the filter 109 to the liquid outlet 113. To prevent microbial growth, the control system 115 operates the UV reactor 111 to at least periodically douse the stagnant liquid within the UV reactor 111 with ultraviolet light. For example, the control system 115 may operate the UV reactor 111 to douse the liquid for 60 seconds every 12 hours while the liquid treatment system 100 is in standby mode.

In some embodiments, the liquid treatment system 100 may have a carbonation system which adds carbon dioxide to the liquid in the liquid channel between the filter 109 and the liquid outlet 113. For example, the carbonation system may have a carbon dioxide air tank configured to store compressed carbon dioxide and selectively release carbon dioxide into the liquid before the liquid is dispensed from the liquid outlet 113. For example, the carbonation system may add carbon dioxide to the liquid between the UV reactor 111 and the liquid outlet 113.

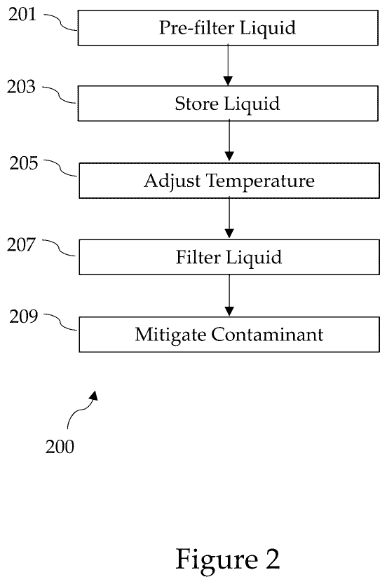

FIG. 2 shows an exemplary Process 200 for treating a liquid with the liquid treatment system 100 in accordance with various embodiments. Process 200 may be implemented in whole or in part with the control system 115. It should be further appreciated that a number of variations and modifications to Process 200 is contemplated including, for example, the omission of one or more aspects of Process 200, the addition of further conditionals and operations, or the reorganization or separation of operations and conditionals into separate processes.

Process 200 begins at operation 201 where liquid enters the liquid treatment system 100 through the liquid inlet 101 and passes through the pre-filter 102, filtering some of the contaminants from liquid. For example, the pre-filter 102 may remove sediment from the liquid, but the pre-filter 102 may not remove an anti-microbial contaminant from the liquid.

After the liquid exits the pre-filter 102, operation 203 stores the liquid in the liquid storage system 103. The liquid stored in the liquid storage system 103 includes an anti-microbial contaminant, such as chlorine. While the chlorine may be removed from the liquid before the liquid is dispensed from the liquid outlet 113, allowing the chlorine to pass through the pre-filter 102 to the liquid storage system 103 hinders microbes from growing in the liquid storage system 103.

Operation 205, which may occur during or after operation 203, includes adjusting the temperature of the liquid. For example, the cooler 105 may decrease the liquid temperature or the heater 107 may increase the liquid temperature. In some embodiments, the Process 200 does not include operation 205.

After the user requests liquid using the HMI 117, liquid flows through an inline portion of the liquid channel of the liquid treatment system 100 where the liquid will not enter a liquid storage system before the liquid is dispensed from the liquid outlet 113. In operation 207 of Process 200, the liquid first passes through the filter 109 where contaminants, including the chlorine, are removed from the liquid.

After the liquid passes through the filter 109, the liquid no longer has chlorine to prevent microbial growth within the final connector 129 and the liquid outlet 113. Operation 209 mitigates microbial growth in the final connector 129 using the UV reactor 111. Mitigating microbial growth may include dousing at least a portion of the liquid within the final connector 129 with ultraviolet light.

The control system 115 may operate the UV reactor 111 in multiple modes to mitigate microbial growth. In a dispensing mode, the UV reactor 111 douses the liquid flowing through the final connector 129 while the liquid treatment system 100 is dispensing liquid from the liquid treatment system. In a standby mode, the UV reactor 111 periodically douses the liquid within at least a portion of the final connector 129 while the liquid is stagnant, i.e., the liquid treatment system 100 is not dispensing liquid from the liquid outlet 113. The UV reactor 111 may douse the liquid according to a schedule based on the time of the last use, temperature, or use history, among other things.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A liquid treatment system, comprising:
a liquid inlet structured to receive a liquid;
a liquid storage system;
a filter structured to remove a first contaminant from the liquid;
an inline ultraviolet (UV) reactor structured to mitigate a second contaminant in the liquid; and
a liquid outlet,
the liquid storage system, the filter, and the inline UV reactor forming a liquid channel between the liquid inlet and the liquid outlet, the liquid outlet being downstream from the liquid inlet, the inline UV reactor and the filter being downstream from the liquid storage system.

2. The liquid treatment system of claim 1, wherein the liquid storage system includes a heat exchanger or a storage tank.

3. The liquid treatment system of claim 1, wherein the liquid treatment system does not include a second liquid storage system downstream from the inline UV reactor or the filter.

4. The liquid treatment system of claim 3, wherein the first contaminant includes chlorine.

5. The liquid treatment system of claim 1, wherein the filter includes a carbon filter.

6. The liquid treatment system of claim 1, wherein the inline UV reactor is structured to operate in a standby mode while the liquid treatment system is not dispensing the liquid.

7. The liquid treatment system of claim 6, wherein the standby mode includes periodically activating a UV-C light of the inline UV reactor.

8. The liquid treatment system of claim 1, wherein the liquid storage system includes a liquid storage system and a heating stage including a heat exchanger, wherein the liquid storage system and the heating stage form parallel liquid subchannels in the liquid channel.

9. The liquid treatment system of claim 1, wherein a maximum cross-sectional area of the liquid channel between the filter and the liquid outlet is less than 15 cm².

10. The liquid treatment system of claim 1, wherein the liquid received at the liquid inlet includes the first contaminant, and wherein the liquid treatment system comprises a pre-filter structured to remove a third contaminant from the liquid.

11. A method for treating a liquid, comprising:
operating a liquid treatment system including a liquid inlet, a liquid storage system, a filter, an inline ultraviolet (UV) reactor, and a liquid outlet;
storing, with the liquid storage system, a liquid;
filtering, with the filter, a first contaminant from the stored liquid; and
mitigating, with the inline UV reactor, a second contaminant in the filtered liquid.

12. The method of claim 11, wherein storing the liquid includes heating the liquid or cooling the liquid.

13. The method of claim 11, wherein the liquid treatment system does not include a second liquid storage system such that the second liquid storage system is downstream from the inline UV reactor or the filter.

14. The method of claim 13, wherein the first contaminant includes chlorine.

15. The method of claim 11, wherein the filter includes a carbon filter.

16. The method of claim 11, comprising:
operating the inline UV reactor in a standby mode while the liquid treatment system is not dispensing the liquid.

17. The method of claim 16, wherein operating in the standby mode includes periodically activating a UV-C light of the inline UV reactor.

18. The method of claim 11, wherein the liquid storage system includes a liquid storage system and a heating stage including a heat exchanger, wherein the liquid storage system and the heating stage form parallel liquid subchannels.

19. The method of claim 11, wherein any cross section of a liquid channel between the filter and the liquid outlet has an area of less than 30 cm².

20. The method of claim 11, wherein the liquid received at the liquid inlet includes the first contaminant, and wherein the method comprises pre-filtering the liquid before storing the liquid to remove a third contaminant.
